(19) United States
(12) Patent Application Publication
(10) Pub. No.: US 2016/0273653 A1
(43) Pub. Date: Sep. 22, 2016

(54) PISTON

(71) Applicant: KAWASAKI JUKOGYO KABUSHIKI KAISHA, Kobe-shi (JP)

(72) Inventors: Hideki TAMASHIMA, Himeji-shi (JP); Hirokazu MATSUDA, Kobe-shi (JP); Takayuki MURATA, Akashi-shi (JP); Daisuke WATANABE, Kobe-shi (JP)

(21) Appl. No.: 14/442,490

(22) PCT Filed: Dec. 12, 2013
(86) PCT No.: PCT/JP2013/083356

§ 371 Date: May 13, 2015

(30) Foreign Application Priority Data
Feb. 7, 2013 (JP) 2013-022550

(51) Int. Cl. F16J 1/09; F04B 53/14; F16J 1/08

(52) U.S. Cl. CPC F16J 1/09; F16J 1/08; F04B 53/14

(57) ABSTRACT

The piston includes a body having a hollow chamber defined therein, and a member inserted in the hollowed chamber to define an oil passage between an inner peripheral surface of the hollow chamber and an opposing outer peripheral surface of the member. This reduces the dead volume and, as a result, improves the compressibility. In addition, the increased cooling performance prevents the fusing of the piston to the cylinder.

### TECHNICAL FIELD

The present invention relates to a piston used in an axial piston motor or an axial piston pump.

### BACKGROUND ART

Typically, the axial piston motor or pump has a rotatable cylinder block. The cylinder block carries cylinders and pistons received in the cylinders so that the pistons move around the axis of the cylinder block with the rotation of the cylinder block as they reciprocate in the axial direction by the engagement with a tilted swash plate, which varies each volume defined by the piston and the associated cylinder to drive the motor or pump. In this motor or pump, the maximum rotational speed and the energy conversion efficiency are important factors for the performance of the motor which may be determined by the pistons to a large extent.

Preferably, to drive the motor or pump at high speeds, the weight of the pistons is reduced. For this purpose, there has been used a hollowed piston 105 shown in FIG. 10.

Due to the existence of the hollowed chamber, the hollow piston 105 disadvantageously leaves a large dead volume between the piston and the cylinder even when the piston takes the upper dead point. This induces a large loss of compressibility in the motor or the pump using high-pressure oil.

To overcome this problem, there has been used a lightweight piston 205 shown in FIG. 11 to reduce its weight and dead volume (See document 1: JP 5-269628 A).

The lightweight piston 205 includes a closed hollow chamber 205a and an oil passage 205b extending through the chamber 205a, and the existence of the closed hollow chamber 205a reduces its weight and minimizes the dead volume.

The existence of the hollow chamber 205a as well as the resultant increased distance between the outer peripheral surface of the piston 205 and the oil passage 205b restricts a heat absorptivity of the oil passing through the oil passage 205b for absorbing heat generated by the frictional contact between the piston 205 and the cylinder. This results in that the cooling performance of the lightweight piston is less than that of the hollow piston, which is likely to cause a fusing of the peripheral outer surface of the piston to the opposed inner peripheral surface of the cylinder.

### PRIOR ART PATENT DOCUMENT

Patent Document 1: JP 5-269628 A

### SUMMARY OF THE INVENTION

### Problem to be Solved by the Invention

Accordingly, a purpose of this invention is to reduce the dead volume to increase the compressibility and to increase a cooling performance of the oil to prevent the fusing of the piston.

### Solution to the Problem

For this purpose, a piston according to the present invention comprises

a body having a longitudinal axis and a hollow chamber defined therein to extend along the longitudinal axis; and

a member inserted in the hollow chamber to define an oil passage between an inner peripheral surface of the hollow chamber and an opposing outer peripheral surface of the inserted member.

According to the piston of this invention, the volume of the oil passage between the inner peripheral surface of the hollow chamber and the outer peripheral surface of the inserted member can be minimized, reducing the dead volume between the cylinder and the piston mounted therein, which minimizes a loss of compressibility and in turn increases an energy conversion efficiency of the pump or motor.

Also, the oil passing through the oil passage flows in contact with the inner peripheral surfaces of the body of the piston and therefore effectively absorbs heat caused by the frictional contacts between the piston and the cylinder, increasing a cooling performance of the piston and the cylinder, which ensures a high speed rotation of the pump or motor.

This reduces the dead volume and, as a result, improves the compressibility. In addition, the increased cooling performance prevents the fusing of the piston to the cylinder.

In another aspect of the invention, the inserted member has a cavity defined therein.

According to this aspect of the invention, a weight of the piston is reduced, which ensures a high speed driving of the pump or motor.

In yet another aspect of the invention, a density of the inserted member is smaller than that of the body.

According to this aspect of the invention, because the weight of the inserted member is smaller than that of the body, the piston can be light-weighted, which ensures a high speed driving of the pump or motor.

In yet another aspect of the invention, the oil passage is one annular oil cavity or is divided into two or more oil cavities when looking at a transverse cross sectional view of the body, in which a ratio of a total circumferential length of the one or more oil cavities to a total circumferential length of the body ranges from 0.5 to 1.

According to this aspect of the piston, because a large portion of the inner peripheral surface of the hollow chamber is used as an oil passage, heat generated by the friction contact between the piston and the cylinder can be removed efficiently by the hydraulic oil, which ensures an increased cooling performance of the pump or the motor.

In yet another aspect of the invention, the oil passage is one annular oil cavity in a transverse cross section of the body.

According to this aspect of the piston, hydraulic oil can contact with the entire inner surface of the hollow chamber of the body, which effectively increases an anti-fusing property.

In yet another aspect of the invention, the oil passage extends helically along the longitudinal axis of the body.

According to this aspect of the piston, hydraulic oil contacts with the entire inner surface of the hollow chamber, which increases the anti-fusing property.

In yet another aspect of the invention, the oil passage is divided into two or more oil cavities which extend linearly in the longitudinal direction of the body.

According to this aspect of the piston, hydraulic oil can contact with inner surface of the hollow chamber, which ensures an increased fusing resistance performance.

In yet another aspect of the invention, the body and the inserted member have respective radially extending surface portions which abut on each other,

the body and the inserted member are connected to each other through a welding provided adjacent a radially outermost end portion of the radially extending surface portions and extending along the longitudinal axis of the body.

According to this aspect of the piston, the welded portion extending in the axial direction situates outside the abutting surface in a radial direction of the body, interfering foreign matters like sputter generating by welling to go into the oil passage by being prevented by the abutting surface during welding the body to the inserted member, which guarantees not to be induced clogging of the oil passage caused by the foreign matters.

### Effects of the Inventions

According to the piston of this invention, an arrangement of the oil passage between the inner peripheral surface of the hollow chamber and the outer peripheral surface of the inserted member reduces the dead volume to increase the compressibility and increase a cooling performance of the oil to prevent the fusing of the piston.

### BRIEF DESCRIPTION OF THE DRAWING

FIG. 1 is a sectional view showing an axial piston motor of the present invention;

FIG. 2 is an axial sectional view showing a first embodiment of the piston according to the invention;

FIG. 3 is a sectional view of the piston in the direction orthogonal to the axis;

FIG. 4 is an axial sectional view showing a second embodiment of the piston according to the invention;

FIG. 5 is a front view showing a third embodiment of the piston according to the invention;

FIG. 6A is a front view showing a fourth embodiment of the piston according to the invention;

FIG. 6B is a right side view showing a fourth embodiment of the piston according to the invention;

FIG. 7 is an enlarged sectional view showing a fifth embodiment of the piston according to the invention;

FIG. 8A is a cross section showing a portion joining the body to the inserted member;

FIG. 8B is a cross section showing a portion joining the body to the inserted member;

FIG. 8C is a cross section showing a portion joining the body to the inserted member;

FIG. 9 is an enlarged sectional view showing a sixth embodiment of the piston according to the invention;

FIG. 10 is sectional view showing a conventional hollow piston; and

FIG. 11 is sectional view showing a conventional light-weighted piston.

### EMBODIMENTS OF THE INVENTION

Hereinafter, this invention will be described in detail by way of embodiments thereof shown in the accompanying drawings.

### First Embodiment

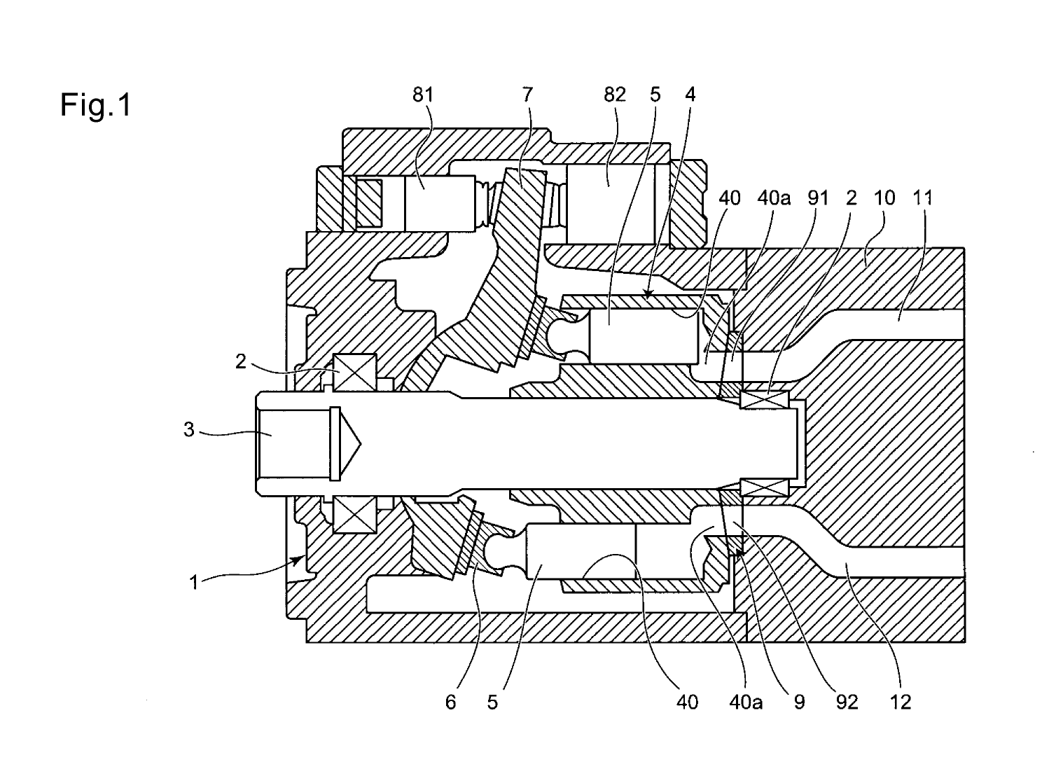

FIG. 1 is a cross sectional view showing an axial piston motor of the invention. As shown in the drawing, the motor has a housing 1, a drive shaft 3 rotatably mounted on the housing 1 through a bearing 2, and a cylinder block 4 securely mounted on the drive shaft 3.

The cylinder block 4 has a plurality of cylinders 40 provided therearound and a plurality of pistons 5 each inserted in the cylinders 40 so that they move inward and outward of the cylinders 40 along longitudinal axes thereof.

The pistons 5 each have a spherical distal end portion which is received by a shoe 6. The shoes 6 are supported by a tilted swash plate 7 positioned relative to the housing 1. The swash plate 7 has a surface which is tilted to a plane orthogonal to the drive shaft 3. The pistons 5 are supported by the tilted surface. The swash plate 7 is supported by first and second pistons 81 and 82 so that the tilting angle of the swash plate 7 can be controlled.

The housing 1 has a cover 10 which covers one end of the drive shaft 3. The cover 10 has first and second passages 11 and 12 fluidly communicated to the cylinders 40 for supplying and discharging hydraulic oil into and out of the cylinders 40.

A valve seat 9 is provided on an end surface of the cover 10, adjacent the cylinder block 4, which has symmetrically-arranged arcuate first and second ports 91 and 92 defined therein.

A port 40a is formed in the bottom of each cylinder 40 so that the hydraulic oil is supplied into and exhausted out of the cylinder 40 through the port 40a. The end surface of the cylinder block 4 is placed on and in contact with the valve seat 9.

The first port 91 of the valve seat 9 makes a fluid communication between the first passage 11 of the cover 10 and the ports 40a of the cylinders 40 opposing the arcuate first port 91, and the second port 92 makes a fluid communication between the second passage 12 of the cover 10 and the ports 40a of the cylinders 40 opposing the arcuate second port 92.

This arrangement allows that the hydraulic oil supplied from the first passage 11 flows through the first port 91 into the cylinders 40 opposing thereto, forcing the associated pistons 5 to cause a rotational movement of the cylinder block 4 and the drive shaft 3 connected thereto. Then, the hydraulic oil in the cylinders 40 are exhausted through the second arcuate port 92 from the second passage 12. Therefore, the pressure of the hydraulic oil in the first passage 11 is higher than that in the second passage 12.

On the other hand, the hydraulic oil supplied into the second passage 12 causes the cylinder block 4 and the drive shaft 3 to rotate in the opposite direction. Then, the hydraulic oil is exhausted from the first passage 11.

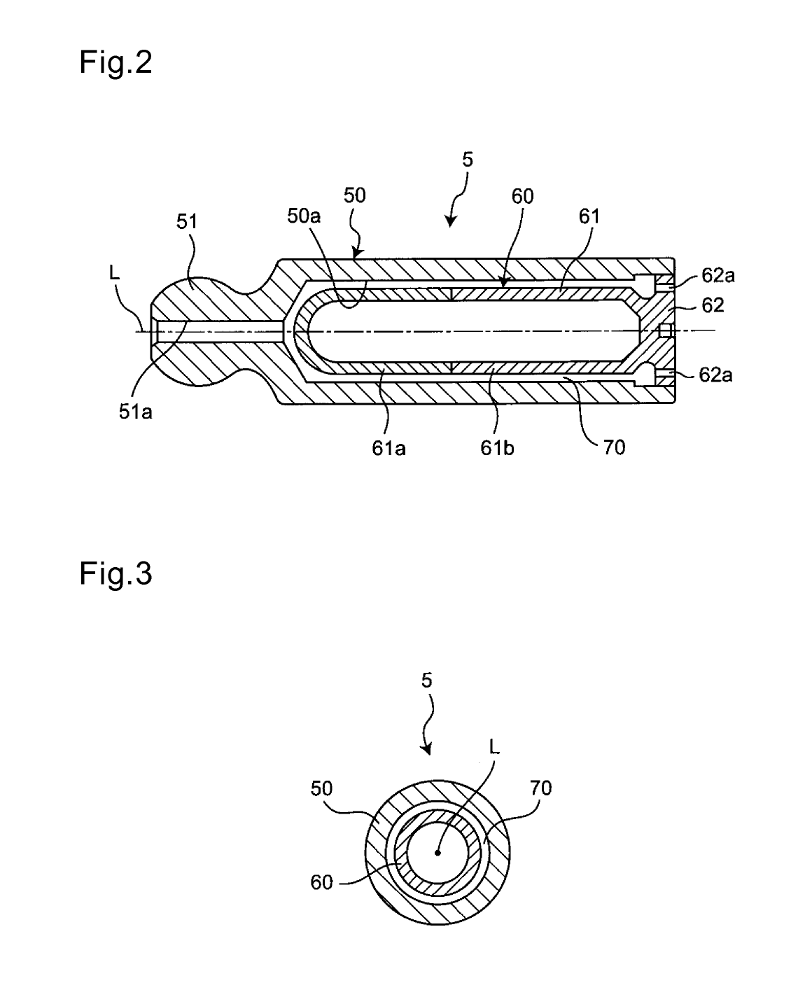

Referring to FIG. 2, the piston 5 includes a body 50 having a hollow chamber 50a defined therein and a member 60 inserted in the hollow chamber 50a.

The body 50 is of hollow cylindrical configuration with one end thereof opened and the other end thereof closed; namely, the hollow chamber 50a is opened at one end and is closed at the other end thereof. The other end of the body 50 has a spherical distal end portion 51 formed therewith. The hollow chamber 50a has an inner cylindrical periphery surface. The distal end portion 51 has a thin passage or hole 51a which is communicated at one end thereof to the hollow chamber 50a.

The inserted member 60 has a cylindrical portion 61 and a closure 62 mounted at one end of the cylindrical portion 61. The cylindrical portion 61 has a first element 61a and a second element 61b, each having a generally cup-shaped longitudinal cross section. The open ends of the first and second elements 61a and the 61b are connected by means of, such as, electron beam welding (EBW) or laser welding. The outer surface of the cylindrical portion 61 has a cylindrical periphery surface. The interior of the cylindrical portion 61 has a hollow cavity defined therein.

The closure 62 is mounted in the opening end of the cylindrical chamber 50a of the piston body 50. The outer periphery of the closure 62 and the opening end of the body 50 are connected by means of, such as, electron beam welding (EBW) or laser welding. The closure 62 has through-holes 62a which communicate with the hollow chamber 50a.

The inner peripheral surface of the hollow chamber 50a of the body 50 and the outer peripheral surface of the inserted member 60 cooperate with each other to define a hydraulic oil passage 70 therebetween. As shown in FIG. 3, the hydraulic oil passage 70 has an annular cross section when viewed from a direction along the axis L of the body 50.

This arrangement allows that the hydraulic oil in the cylinder 40 flows through the through-holes 62a of the closure 62 into the oil passage 70 and then exhausted therefrom through the thin passage 51a of the distal end 51, of the body 50. The exhausted oil is then supplied between the distal end portion 51 and the shoe 6 for the lubrication thereof.

According to the piston 5 so constructed, the volume of the oil passage 70 defined between the inner surface of the hollow chamber 50a of the body 50 and the outer surface of the inserted member 60 can be minimized as much as possible, reducing the dead volume between the piston 5 and the cylinder 40, which decreases the compressibility loss and increases the energy conversion efficiency of the motor.

Also, the hydraulic oil flowing through the passage 70 makes a fluid contact with the inner surface of the hollow chamber 50a, allowing the hydraulic oil to effectively absorb the heat caused by the frictional contacts between the piston 5 and the cylinder 40, which increases the cooling efficiency of the contact surfaces of the piston 5 and the cylinder 40 to ensure a high speed driving of the motor.

This reduces the dead volume and the compressibility loss and increases the anti-fusing property.

Also, the hollow cavity of the inserted member 60 reduces the weight of the piston 5, which ensures that the motor is driven at a higher speed.

Further, when the oil passage 70 has the annular configuration in each transverse cross section of the body 50, the hydraulic oil contacts the entire inner surface of the hollow chamber 50a of the body 50, which effectively increases the anti-fusing property of the piston 5.

However, a portion or portions of the outer periphery surface of the inserted member 60 may contact the inner periphery surface of the body 50 due to production error thereof to form a crescent cross sectional passage portion.

In this instance, when looking at a transverse cross sectional view of the body 50, the piston 5 can be seen as if the oil passage 70 is divided into two or more oil cavities, in which a ratio of the total circumferential length of the oil cavities to the total circumferential length of the body ranges from 0.5 to 1.

This ensures that a large portion of the inner surface of the hollow chamber 50a is used as an oil passage 70, allowing the hydraulic oil to effectively absorb heat caused by the frictional contacts between the piston 5 and the cylinder 40, which increases the cooling efficiency of the contact surfaces of the piston 5 and the cylinder 40.

If a ratio of the total circumferential length of one or more oil cavities which are provided between the inner surface of the hollow chamber 50a and the outer periphery surface of the inserted member 60 to the total circumferential length of the body 50 ranges from 0.7 to 1 when looking at a transverse cross sectional view of the body 50, a remarkable effect is generated.

### Second Embodiment

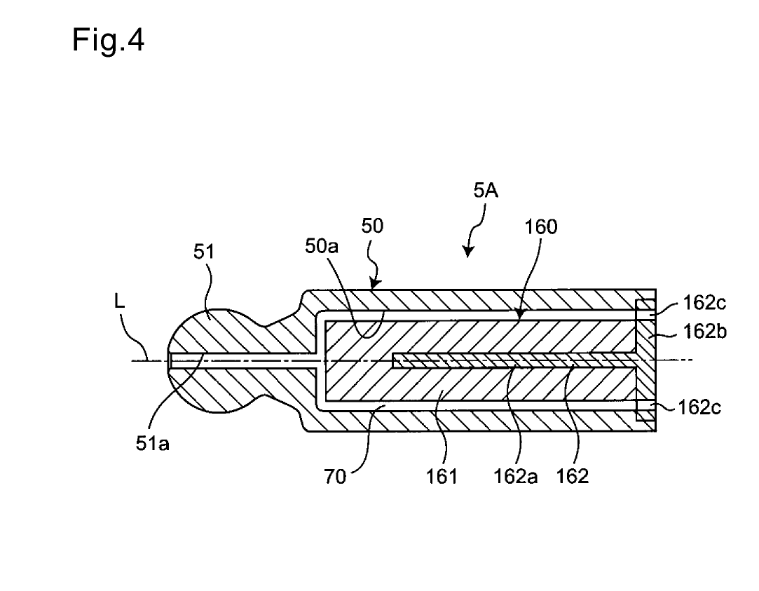

FIG. 4 is an axial sectional view showing a second embodiment of the piston according to the invention. The second embodiment differs from the first embodiment in terms of the inserted member which will be described below. In the second embodiment, like parts are designated by like reference numerals throughout the drawings in order to eliminate duplicate descriptions thereof.

As shown in FIG. 4, a piston 5A has an inserted member 160 which has a filling portion 161 and a pin portion 162 to secure the filling portion 161. The filling portion 161 is of hollow cylindrical configuration. The inner surface of the hollow chamber 50a of the body 50 and the outer surface of the filling portion 161 cooperate to define a hydraulic oil passage 70 therebetween.

The pin portion 162 has a shaft portion 162a and a head portion 162b mounted at one end of the shaft portion 162a. The shaft portion 162a is fitted in the filling portion 161. The head portion 162b is mounted in the opening end of the hollow chamber 50a of the body 50 so that it serves as a closure member for closing the hollow chamber 50a. An outer peripheral edge of the head portion 162b and the opening end of the body 50 are connected by means of, such as, electron beam welding (EBW) or laser welding. The head portion 162b has through-holes 162c which communicate with the hollow chamber 50a.

The density of the inserted member 160 is smaller than that of the body 50. Here, the density of the inserted member 160 means a combined mass for unit volume of the filling portion 161 and the pin portion 162. For example, the filling portion 161 is made from resin, and the pin, portion 162 and the piston body 50 are made from metal.

Accordingly, the density of the inserted member 160 is smaller than that of the body 50, reducing the weight of the piston 5A, which ensures a high speed driving of the pump or motor.

### Third Embodiment

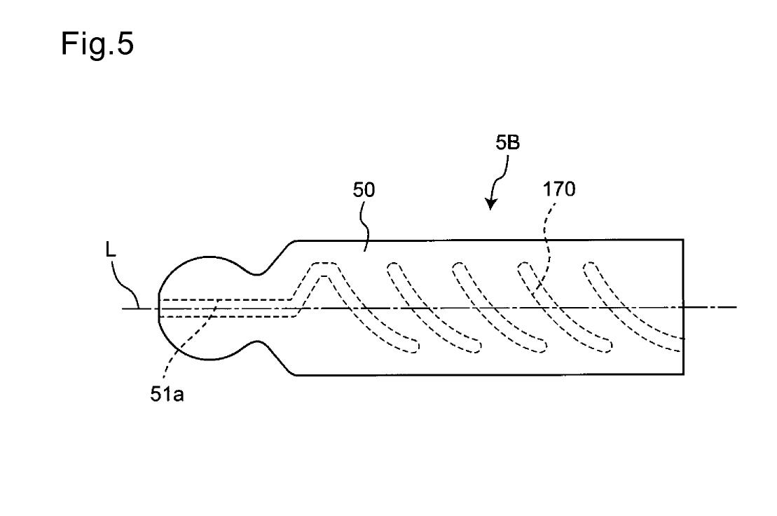

FIG. 5 is an axial sectional view showing a third embodiment of the piston according to the invention. The third embodiment differs from the first embodiment in terms of the oil passage which will be described below. In the third embodiment, like parts are designated by like reference numerals throughout the drawings in order to eliminate duplicate descriptions thereof.

As shown in FIG. 5, an oil passage 170 of a piston 5B extends helically along the longitudinal axis L of body 50. The helical oil passage 170 is made of groove or grooves formed in at least one of the inner peripheral surface of the piston body 50 and the outer peripheral surface of the inserted member 60.

The helical arrangement of the oil passage 170 allows the hydraulic oil to contact with the entire inner peripheral surface of the hollow chamber 50a, which reliably increases the anti-fusing property of the piston 5B.

In the piston 5B of this third embodiment, the passage 70 is one annular cavity or is divided into two or more cavities when looking at a transverse cross sectional view of the body 50, in which a ratio of the total circumferential length of the oil cavity or the oil cavities to the total circumferential length of the body 50 may range from 0.5 to 1.

Accordingly, a large portion of the inner peripheral surface of the hollow chamber 50a serves as the oil passage 170, allowing the hydraulic oil to effectively collect the heat generated by the frictional contact between the piston 5B and the cylinder 40, which ensures an increased cooling performance of the pump or the motor.

If a ratio of the total circumferential length of one or more oil cavities which are provided between the inner surface of the hollow chamber 50a and the outer periphery surface of the inserted member 60 to the total circumferential length of the body 50 ranges from 0.7 to 1 when looking at a transverse cross sectional view of the body 50, a remarkable effect is generated.

### Fourth Embodiment

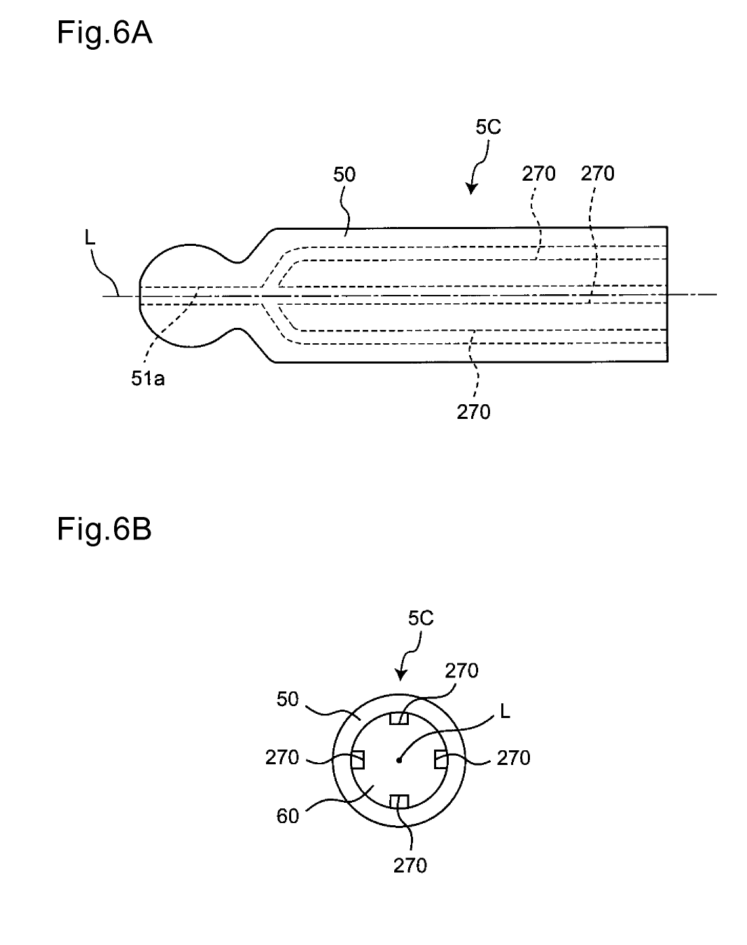

FIG. 6A is a front view showing a fourth embodiment of the piston according to the invention. FIG. 6B is a right side view of the piston. The fourth embodiment differs from the first embodiment in terms of the oil passage which will be described below. In the fourth embodiment, like parts are designated by like reference numerals throughout the drawings in order to eliminate duplicate descriptions thereof.

As shown in FIGS. 6A and 6B, the oil passage has four oil cavities 270 extending linearly in a direction parallel to the longitudinal axis L of the piston body 50 and positioned at regular angles around the axis, i.e., spacing 90 degrees. Preferably, the oil cavities 270 are made of grooves formed in at least one of the inner peripheral surface of the piston body 50 and the inserted member 60.

The number of the oil cavities is not limited to four; namely, two or more oil cavities may be provided. Also, the oil cavities may be positioned at irregular intervals around the axis.

The linear oil cavities 270 formed in the inner peripheral surface of the piston body 50 and/or the outer peripheral surface of the inserted member 60 around the longitudinal axis L of the piston body 50 allows the oil to bring into contact with the inner surface of the hollow chamber 50a of the piston body 50 in a reliable manner, which effectively increases an anti-fusing property of the piston 5C.

In the piston 5C of this fourth embodiment, the passage is one annular cavity or is divided into two or more cavities 270 when looking at a transverse cross sectional view of the body 50, in which a ratio of the total circumferential length of the oil cavity or the oil cavities to the total circumferential length of the body 50 may range from 0.5 to 1.

This ensures that a large portion of the inner surface of the hollow chamber 50a is used as an oil passage, allowing the hydraulic oil to effectively absorb heat caused by the frictional contacts between the piston 5B and the cylinder 40, which increases the cooling efficiency of the contact surfaces of the piston 5B and the cylinder 40.

If a ratio of the total circumferential length of one or more oil cavities which are provided between the inner surface of the hollow chamber 50a and the outer periphery surface of the inserted member 60 to the total circumferential length of the body 50 ranges from 0.7 to 1 when looking at a transverse cross sectional view of the body 50, a remarkable effect is generated.

### Fifth Embodiment

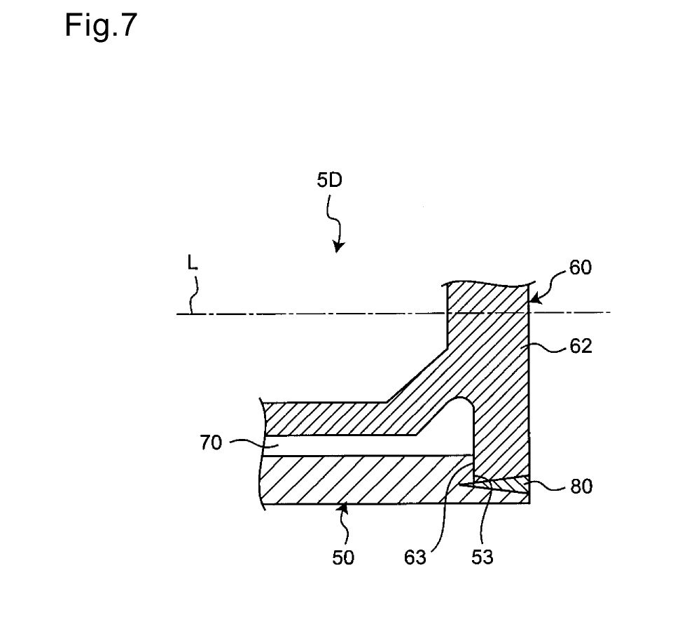

FIG. 7 is an enlarged sectional view showing a fifth embodiment of the piston according to the invention. The fifth embodiment differs from the first embodiment in terms of welded structure where a body and a inserted member are welded. In the fifth embodiment, like parts are designated by like reference numerals throughout the drawings in order to eliminate duplicate descriptions thereof.

In the piston 5D shown in FIG. 7, the opening end of the piston body 50 has at its periphery a radial surface portion 53 extending in a radial direction of the piston body 50 and the closure portion 62 of the inserted member 60 has at its periphery an associated radial surface portion 63 which is configured to abut the surface portion 53 of the piston body 50.

The inserted member 60 is secured to the piston body 50 by welding 80 or welding bead provided adjacent the outermost peripheral ends of the abutting surface portions 53 and 63. As seen in the drawing, the welding 80 extends and intersects at a right angle with the abutting surface portions 53 and 63.

Descriptions will be made to a connecting method between the piton body 50 and the inserted member 60.

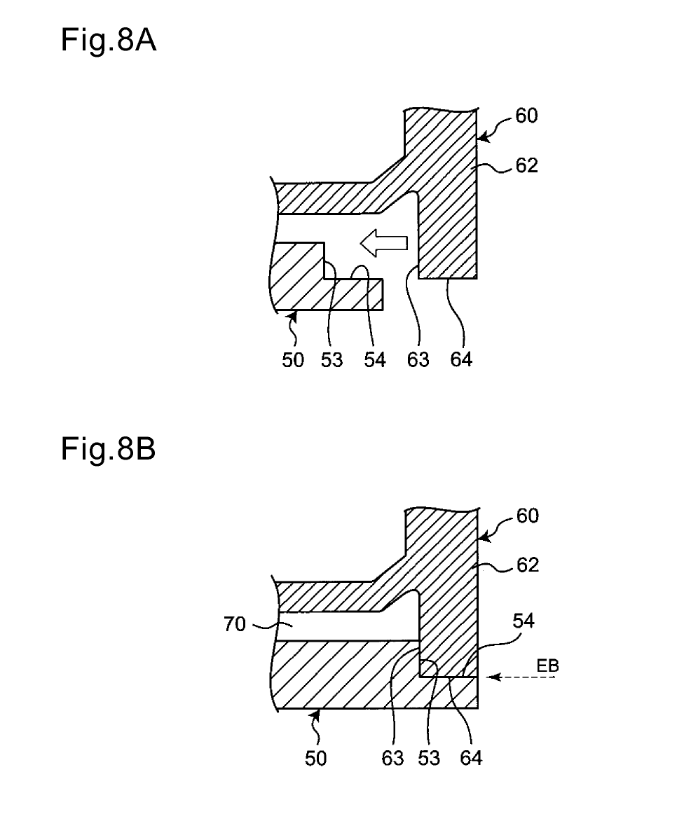

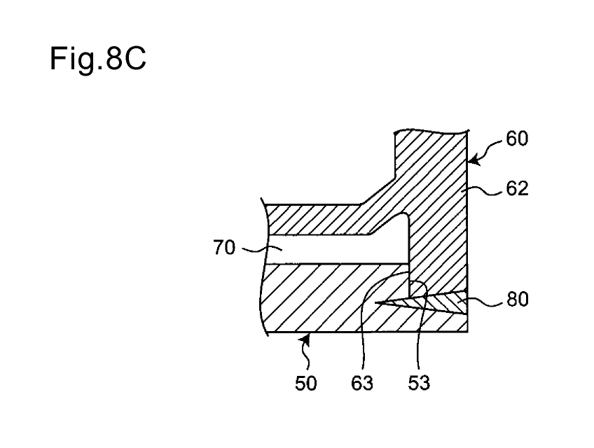

As shown in FIG. 8A, the piston body 50 is formed with the radial abutting surface portion 53 and the axial mating surface portion 54 extending in a direction parallel to the longitudinal axis L from the outermost end of the radial abutting surface portion 53. As can be seen, radial and axial surface portions 53 and 54 form a part of faucet joint structure at the opening end of the piston body 50. Correspondingly, the inserted member 60 is formed with the radial abutting surface portion 63 and the mating surface portion 64 extending from the outermost end of the radial abutting surface portion 63.

As shown in FIG. 8B, the closure portion 62 of the inserted member 60 is fitted in the opening of the piston body 50 with abutting surface 63 of the inserted member 60 slidingly engaging on the associated abutting surface 53 of the piston body 50 until the abutting surface 63 of the inserted member 60 abuts the associated abutting surface 53 of the piston body 50. Then, an electron beam is projected in the direction parallel to the longitudinal axis L toward the contacted surfaces 54 and 64 of the piston body 50 and the inserted member 60.

This causes the welding 80 which extends in the direction parallel to the longitudinal axis L of the piston body 50 at a position adjacent the radially outermost ends of the abutting surface portions 53 and 63 to firmly connect the piston body 50 and the inserted member 60.

With the above arrangement of the piston 5D, the axially extending welding 80 positions radially outside the radial extending abutting surface portions 53 and 63 of the piston body 50, which prevents foreign matters such as sputter caused at the welding at between the piston body 50 and the inserted member 60 from entering into the oil passage 70. This in turn prevents a clogging of the oil passage 70 and a reduction in fatigue strength which would otherwise be caused by the foreign matters or sputters.

### Sixth Embodiment

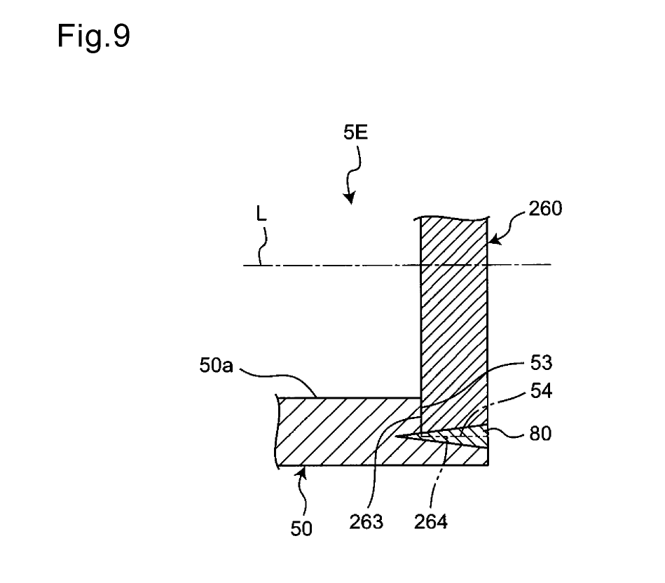

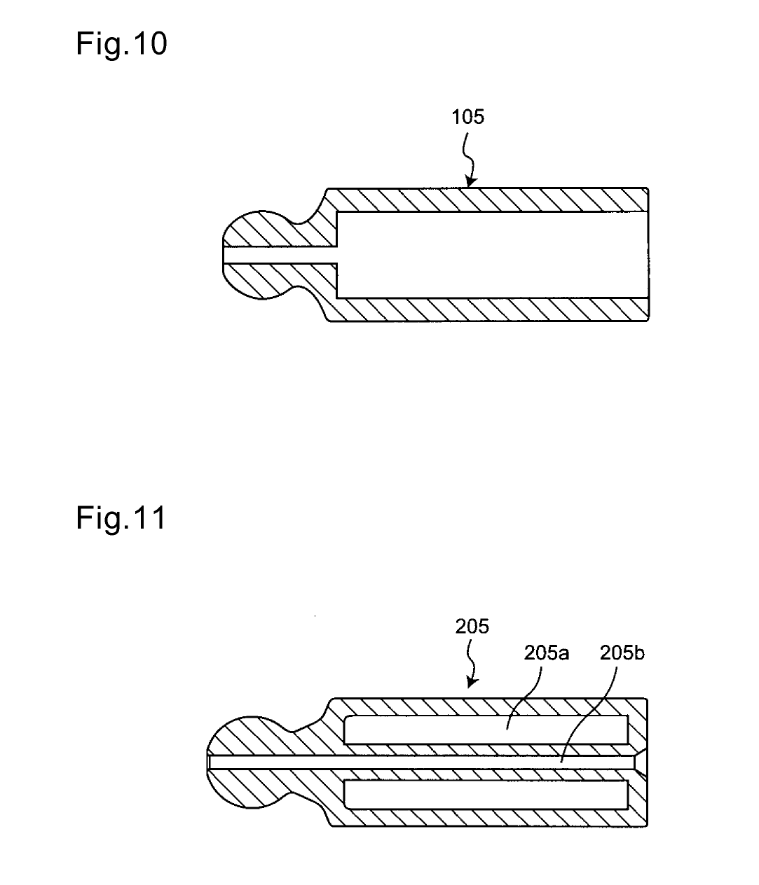

FIG. 9 is an enlarged sectional view showing a sixth embodiment of the piston according to the invention. The sixth embodiment differs from the first embodiment in terms of using a closer instead of using an inserted member. In the sixth embodiment, like parts are designated by like reference numerals throughout the drawings in order to eliminate duplicate descriptions thereof.

As shown in FIG. 9, a piston 55 comprises a body 50 having a hollow chamber 50a and a closure 260 secured at the opening end of the hollow chamber 50a of the body 50.

As can be seen in the longitudinal cross section of the piston body 50, the opening end of the body 50 has an abutting surface portion 53 extending in a radial direction of the body 50, and an outer peripheral edge of the closure 62 has an abutting surface portion 263 extending in a radial direction of the body 50. The abutting surface 53 of the body 50 and the abutting surface 263 of the closure 260 abut on each other.

A welding 80 which secures between the body 50 and the closure 260 is positioned radially adjacent and outside the abutting surface portions 53 and 263. The welding 80 extends in a direction parallel to the longitudinal axis L of the body 50 so that it intersects the abutting surface portions 53 and 263.

Descriptions will be made to a connecting method between the piton body 50 and the closure 260, which is similar to that described above with reference to FIGS. 8A to 8C.

As shown in FIG. 9, the piston body 50 is formed with the radial abutting surface portion 53 and the axial mating surface portion 54 extending in a direction parallel to the longitudinal axis L from the outermost end of the radial abutting surface portion 53. As can be seen, radial and axial surface portions 53 and 54 form a part of faucet joint structure at the opening end of the piston body 50. Correspondingly, the closer 260 is formed with the radial abutting surface portion 263 and the mating surface portion 264 extending from the outermost end of the radial abutting surface portion 263.

The closer 260 is fitted in the opening of the piston body 50 with abutting surface 263 of the closer 260 slidingly engaging on the associated abutting surface 53 of the piston body 50 until the abutting surface 263 of the closer 60 abuts the associated abutting surface 53 of the piston body 50. Then, an electron beam is projected in the direction parallel to the longitudinal axis L toward the contacted surfaces 54 and 264 of the piston body 50 and the closer 260.

This causes the welding 80 which extends in the direction parallel to the longitudinal axis L of the piston body 50 at a position adjacent the radially outermost ends of the abutting surface portions 53 and 263 to firmly connect the piston body 50 and the closer 260.

With the above arrangement of the piston 5E, the axially extending welding 80 positions radially outside the radial extending abutting surface portions 53 and 263 of the piston body 50, which prevents foreign matters such as sputter caused at the welding between the piston body 50 and the closer 260 from entering into the hollow chamber 50a. This in turn prevents a clogging of the hollow chamber 50a and damage of the inner surface of the hollow chamber 50a which would otherwise be caused by the foreign matters in the welding.

The closure 260 is attached to the opening end of the hollow chamber 50a, which reduces the dead volume and therefore minimizes a loss of compressibility of the hydraulic oil flowing into the hollow chamber 50a of the body 50. Also, the hydraulic oil flows in contact with the inner surface of the hollow chamber 50a of the body 50 and therefore effectively absorbs heat caused by the frictional contacts between the piston 5E and the cylinder 40, increasing a cooling performance of the piston and the cylinder, which ensures effectively increases an anti-fusing property.

Although in the sixth embodiment the closure 260 free from inserted member is used, it may be replaced by, for example, the closure member 62 with the inserted member 60 as described in the first embodiment or the head portion 162b with the inserted member 160 as described in the second embodiment. In those embodiments, the foreign matters such as sputters generated at the welding 80 of the piston body 50 and the inserted members 60 and 160 are prohibited by the abutting surface portions 53 and 263 from entering into the oil passage 70, which in turn prevents any clogging in the oil passage 70 due to such foreign matters such as sputters.

The present invention is not limited to the above-described embodiments. A variety of modifications which selectively combine features described in the first to sixth embodiments may fall within the scope of the invention.

Although in the above-described embodiments the piston of the present invention is applied to the axial piston motor, it may be applied to an axial piston pump.

Although in the above-described embodiments the welding is used for fixing the inserted member to the piston body, it may be replaced by, for example, frictional engaging, brazing, ring connecting, or press-fitting technique.

Although in the above-described embodiments the oil passage has a plurality of linear oil cavities, the oil passage may have only one linear oil cavity.

The piston may form a crescent cross sectional passage portion over the entire axial length of the body when looking at a transverse cross sectional view of the body of the piston or may form an another shaped cross sectional passage portion. At least one passage (cavity) may have shape different from that of another passage (cavity). In this case, the passage is one annular cavity or is divided into two or more cavities when looking at a transverse cross sectional view of the body, in which a ratio of the total circumferential length of the oil cavity or the oil cavities to the total circumferential length of the body may range from 0.5 to 1.

Although descriptions have been made to embodiments in which the piston has a spherical portion formed at its distal end and the shoe has a seat for receiving the spherical portion, they may be provided in different way such that the shoe has a spherical portion and the piston has a seat for receiving the spherical portion.

The inserted member of the first embodiment may be hollowed regardless of whether the oil passage has an annular configuration. Also, the density of the inserted member may be smaller than that of the piston body regardless of whether the oil passage has the annular configuration or the inserted member is hollowed.

### DESCRIPTION OF REFERENCE SIGNS

1: Housing

3: Drive shaft

4: Cylinder block

5, 5A, 5B, 5C, 5D, 5E: Piston

7: Swash plate

9: Valve plate

10: Cover

40: Cylinder

50: Body

50a: Hollow chamber

53: Abutting surface

54: Connecting surface

60: Inserted member

61: Cylinder portion

62: Closure

63: Abutting surface

64: Connecting surface

70, 170: Oil passage

80: Welded portion

160: Inserted member

161: Filling portion

162: Pin portion

260: Closure

270: Oil cavities

263: Abutting surface

264: Connecting surface

L: Axis of body

1. A piston, comprising:
a body having a longitudinal axis and a hollow chamber defined therein to extend along the longitudinal axis; and
a member inserted in the hollow chamber to define an oil passage between an inner peripheral surface of the hollow chamber and an opposing outer peripheral surface of the inserted member.

2. The piston according to claim 1, wherein the inserted member has a cavity defined therein.

3. The piston according to claim 1, wherein a density of the inserted member is smaller than that of the body.

4. The piston according to claim 1, wherein the oil passage is one annular oil cavity or is divided into two or more oil cavities when looking at a transverse cross sectional view of the body, in which a ratio of a total circumferential length of the one or more oil cavities to a total circumferential length of the body ranges from 0.5 to 1.

5. The piston according to claim 1, wherein the oil passage is one annular oil cavity in a transverse cross section of the body.

6. The piston according to claim 1, wherein the oil passage extends helically along the longitudinal axis of the body.

7. The piston according to claim 1, wherein the oil passage is divided into two or more oil cavities which extend linearly in the longitudinal direction of the body.

8. The piston according to claim 1, wherein
the body and the inserted member have respective radially extending surface portions which abut on each other,
the body and the inserted member are connected to each other through a welding provided adjacent a radially outermost end portion of the radially extending surface portions and extending along the longitudinal axis of the body.
